(19) United States
(12) Patent Application Publication
(10) Pub. No.: US 2012/0194655 A1
(43) Pub. Date: Aug. 2, 2012

(54) DISPLAY, IMAGE PROCESSING APPARATUS AND IMAGE PROCESSING METHOD

(76) Inventor: Hsu-Jung Tung, Hsinchu County (TW)

(21) Appl. No.: 13/304,703

(22) Filed: Nov. 28, 2011

(30) Foreign Application Priority Data
Jan. 28, 2011 (TW) 100103318

(51) Int. Cl. H04N 13/04

(52) U.S. Cl. 348/51; 348/E13.075; 348/E13.033

(57) ABSTRACT

An image processing apparatus positioned in a display includes a receiving unit, a color separation unit and an image processing unit. The receiving unit is utilized for receiving 3D image data, where the 3D image data includes left-eye image data and right-eye image data. The color separation unit is coupled to the receiving unit, and is utilized for performing a color separation operation upon at least a portion of the left-eye image data to generate color-separated left-eye image data, and performing the color separation operation upon at least a portion of the right-eye image data to generate color-separated right-eye image data. The image processing unit is coupled to the color separation unit, and is utilized for generating adjusted 3D image data according to the color-separated left-eye image data and the color-separated right-eye image data.

### BACKGROUND OF THE INVENTION

1. Field of the Invention

The present invention relates to an image processing apparatus, and more particularly, to an image processing apparatus and an associated method which performs a color separation operation upon received 3D image data.

2. Description of the Prior Art

As 3D technology progresses and 3D video becomes more popular, many 3D TV and peripheral devices are developed to provide 3D video to users. However, these 3D TV generally needs high-level panels (e.g., the operation frequency of the panel is equal to 120 Hz or 240 Hz, or the panel has an additional polarizer), or the user must use a special glasses (such as shutter glasses) to watch these 3D TV. Therefore, the costs of the 3D TV and the peripheral devices will be much higher, and the user may feel that these 3D TV are too expensive.

### SUMMARY OF THE INVENTION

It is therefore an objective of the present invention to provide an image processing apparatus and image processing method, which is able to make the user to use less cost to watch 3D video, to solve the above-mentioned problem.

According to one embodiment of the present invention, an image processing apparatus positioned in a display comprises a receiving unit, a color separation unit and an image processing unit. The receiving unit is utilized for receiving 3D image data, where the 3D image data includes left-eye image data and right-eye image data. The color separation unit is coupled to the receiving unit, and is utilized for performing a color separation upon at least a portion of the left-eye image data to generate color-separated left-eye image data, and performing the color separation upon at least a portion of the right-eye image data to generate color-separated right-eye image data, where each of the color-separated left-eye image data and the color-separated right-eye image data corresponds to only one or two of three primary colors, the three primary colors include red, green and blue, and the color-separated left-eye image data and the color-separated right-eye image data do not have the data correspond to the same primary color. The image processing unit is coupled to the color separation unit, and is utilized for generating adjusted 3D image data according to the color-separated left-eye image data and the color-separated right-eye image data.

According to another embodiment of the present invention, an image processing method applied to a display includes: receiving 3D image data, where the 3D image data includes left-eye image data and right-eye image data; performing a color separation upon at least a portion of the left-eye image data to generate color-separated left-eye image data, and performing the color separation upon at least a portion of the right-eye image data to generate color-separated right-eye image data, where each of the color-separated left-eye image data and the color-separated right-eye image data corresponds to only one or two of three primary colors, the three primary colors include red, green and blue, and the color-separated left-eye image data and the color-separated right-eye image data do not have the data correspond to the same primary color; generating adjusted 3D image data according to the color-separated left-eye image data and the color-separated right-eye image data.

According to another embodiment of the present invention, an image processing apparatus positioned in a display includes a receiving unit, an image processing unit and a color separation unit. The receiving unit is utilized for receiving 3D image data, where the 3D image data includes left-eye image data and right-eye image data. The image processing unit, coupled to the receiving unit, and is utilized for processing the left-eye image data and the right-eye image data to generate processed left-eye image data and processed right-eye image data, respectively. The color separation unit is coupled to the image processing unit, and is utilized for performing a color separation upon at least a portion of the processed left-eye image data to generate a color-separated left-eye image data, and performing the color separation upon at least a portion of the processed right-eye image data to generate a color-separated right-eye image data, where each of the color-separated left-eye image data and the color-separated right-eye image data corresponds to only one or two of three primary colors, the three primary colors include red, green and blue, and the color-separated left-eye image data and the color-separated right-eye image data do not have the data correspond to the same primary color.

According to another embodiment of the present invention, an image processing method applied to a display includes: receiving 3D image data, where the 3D image data includes left-eye image data and right-eye image data; processing the left-eye image data and the right-eye image data to generate processed left-eye image data and processed right-eye image data, respectively; and performing a color separation upon at least a portion of the processed left-eye image data to generate a color-separated left-eye image data, and performing the color separation upon at least a portion of the processed right-eye image data to generate a color-separated right-eye image data, where each of the color-separated left-eye image data and the color-separated right-eye image data corresponds to only one or two of three primary colors, the three primary colors include red, green and blue, and the color-separated left-eye image data and the color-separated right-eye image data do not have the data correspond to the same primary color

According to another embodiment of the present invention, a display includes a display panel and an image processing apparatus, where the image processing apparatus includes a receiving unit, a color separation unit and an image processing unit. The receiving unit is utilized for receiving 3D image data, where the 3D image data includes left-eye image data and right-eye image data. The color separation unit is coupled to the receiving unit, and is utilized for performing a color separation upon at least a portion of the left-eye image data to generate a color-separated left-eye image data, and performing the color separation upon at least a portion of the right-eye image data to generate a color-separated right-eye image data, where each of the color-separated left-eye image data and the color-separated right-eye image data corresponds to only one or two of three primary colors, the three primary colors include red, green and blue, and the color-separated left-eye image data and the color-separated right-eye image data do not have the data correspond to the same primary color. The image processing unit is coupled to the color separation unit, and is utilized for generating adjusted 3D image data according to the color-separated left-eye image data and the color-separated right-eye image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an image processing apparatus according to one embodiment of the present invention

FIG. 2 is a diagram showing two video data formats.

FIG. 3 is a flowchart of an image processing method according to one embodiment of the present invention.

FIG. 4 is a diagram illustrating an image processing apparatus according to another embodiment of the present invention

FIG. 5 is a diagram illustrating an image processing apparatus according to another embodiment of the present invention.

FIG. 6 is a flowchart of an image processing method according to another embodiment of the present invention.

FIG. 7 is a flowchart of an image processing method according to another embodiment of the present invention

FIG. 8 is a diagram illustrating an image processing method according to another embodiment of the present invention.

### DETAILED DESCRIPTION

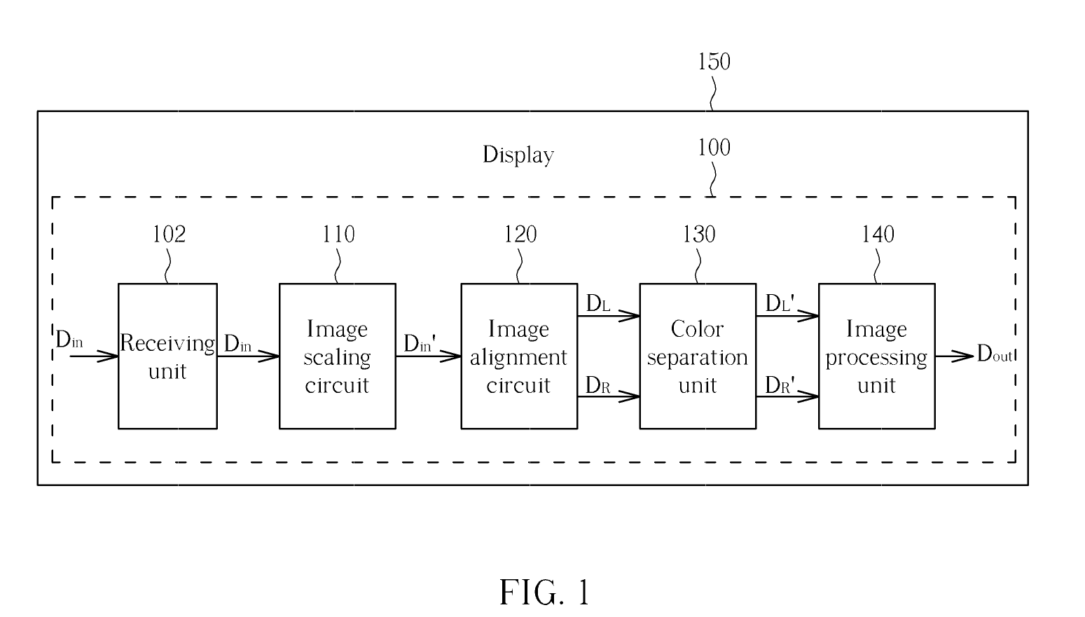

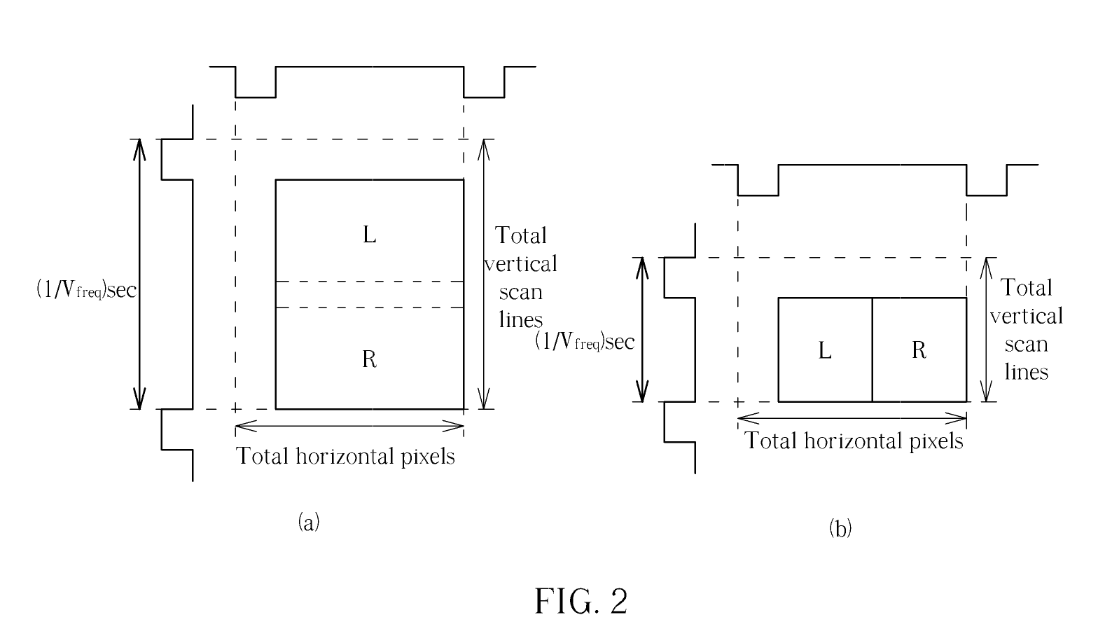

Please refer to FIG. 1, which illustrates an image processing apparatus 100 according to one embodiment of the present invention. As shown in FIG. 1, the image processing apparatus 100 includes a receiving unit 102, an image scaling circuit 110, an image alignment circuit 120, a color separation unit 130 and an image processing unit 140. The image processing apparatus 100 is positioned in a display 150 (in this embodiment, the display 150 may have a 3D display panel or a 2D panel), and is utilized for performing an image processing operation upon 3D image data Din to generate adjusted 3D image data Dout, where the 3D image data Din can be from a video disc or any other video source. In addition, in this embodiment, the 3D image data Din satisfies High-Definition Multimedia Interface (HDMI) standard, and the 3D video formats are shown in sub-figures (a) and (b) of FIG. 2. Because the detailed description of the 3D video formats shown in FIG. 2 can be seen in the HDMI 1.4 specification, further descriptions are therefore omitted here.

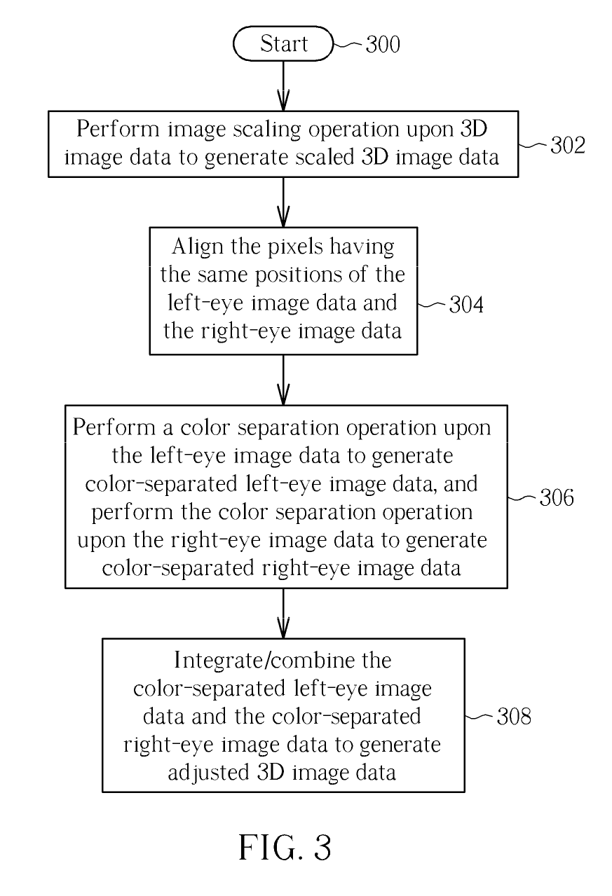

Please refer to FIG. 1 and FIG. 3 together. FIG. 3 is a flow chart of an image processing method according to one embodiment of the present invention. It is noted that, provided the results are substantially the same, the steps are not limited to be executed according to the exact order shown in FIG. 3. Referring to FIG. 3, the flow is described as follows.

In Step 300, the flow starts. Then, in Step 302, the receiving unit 102 receives 3D image data Din, and the image scaling circuit 110 performs an image scaling operation upon the 3D image data Din to generate scaled 3D image data Din′. Taking the video format shown in (b) of FIG. 2 as an example, the image scaling circuit 110 scales up the horizontal pixels of the left-eye image data “L” and the right-eye image data “R” to generate image data having data format similar to the left-eye image data “L” and the right-eye image data “R” shown in (a) of FIG. 2 (the left-eye image data “L” and the right-eye image data “R” shown in (a) of FIG. 2 include all the pixels displayed on a screen of the display 150). It is noted that, however, if the 3D image data Din has the video format shown in (a) of FIG. 2, the image scaling circuit 110 does not need to scale the 3D image data Din, that is, the step 302 can be ignored.

Then, in Step 304, the image alignment circuit 120 aligns the pixels having the same positions of the left-eye image data and the right-eye image data of the scaled 3D image data Din′, and transmits an aligned left-eye image data D_{L} and right-eye image data D_{R} to the color separation unit 130. In addition, the image alignment circuit 120 can store the scaled 3D image data Din′ into a buffer, and then aligns the pixels having the same positions of the left-eye image data and the right-eye image data of the scaled 3D image data Din′; or the image alignment circuit 120 can use a delay circuit to align the pixels having the same positions of the left-eye image data and the right-eye image data of the scaled 3D image data Din′.

Then, in Step 306, the color separation unit 130 performs a color separation operation upon the left-eye image data D_{L} to generate a color-separated left-eye image data D_{L}′, and performs the color separation operation upon the right-eye image data D_{R} to generate a color-separated right-eye image data D_{R}′, where each of the color-separated left-eye image data D_{L}′ and the color-separated right-eye image data D_{R}′ corresponds to only one or two of three primary colors, the three primary colors include red, green and blue, and the color-separated left-eye image data D_{L}′ and the color-separated right-eye image data D_{R}′ do not have the data correspond to the same primary color. For example, the color separation unit 130 may delete the pixel values corresponding to the primary color “red” of the left-eye image data D_{L} (i.e., the color-separated left-eye image data D_{L}′ only has pixel values corresponding to the primary colors “green” and “blue”), and delete the pixel values corresponding to the primary colors “green” and “blue” of the right-eye image data D_{R} (i.e., the color-separated right-eye image data D_{R}′ only has pixel values corresponding to the primary color “red”).

Finally, in Step 308, the image processing unit 140 integrates/combines the color-separated left-eye image data D_{L}′ and the color-separated right-eye image data D_{R}′ to generate adjusted 3D image data Dout, and transmits the adjusted 3D image data Dout to the following circuit and to be displayed on a screen. In detail, a frame of the adjusted 3D image data Dout includes all the pixel values of the color-separated left-eye image data D_{L}′ and the color-separated right-eye image data D_{R}′, that is, the frame of the adjusted 3D image data Dout includes the pixel values corresponding to the primary colors “green” and “blue” of the left-eye image data D_{L} and the pixel values corresponding to the primary color “red” of the right-eye image data D_{R}. Therefore, the pixel values corresponding to the primary colors “green” and “blue” of the left-eye image data D_{L} and the pixel values corresponding to the primary color “red” of the right-eye image data D_{R} are displayed on the screen simultaneously.

As described above, because the display only shows the pixel values corresponding to the primary colors “green” and “blue” of the left-eye image data D_{L} and the pixel values corresponding to the primary color “red” of the right-eye image data D_{R}, the user can simply use a glass having a bluish green glassine covered on the left eye and a red glassine covered on the right eye to enjoy the 3D video. In addition, because the video format of the adjusted 3D image data Dout is substantially a 2D video format, the display 150 can use a conventional display panel (e.g., 2D panel) without using a high-level 3D display panel. Therefore, the user does not need to buy the expensive 3D TV and the peripheral device to enjoy the 3D video.

In addition, the positions of the image scaling circuit 110 on the image processing apparatus 100 is merely an example, and is not to be a limitation of the present invention. In another embodiment of the present invention, the image scaling circuit 110 can be positioned after the image alignment circuit 120, or after the color separation unit 130, or after the image processing unit 140. These alternative designs should fall within the scope of the present invention.

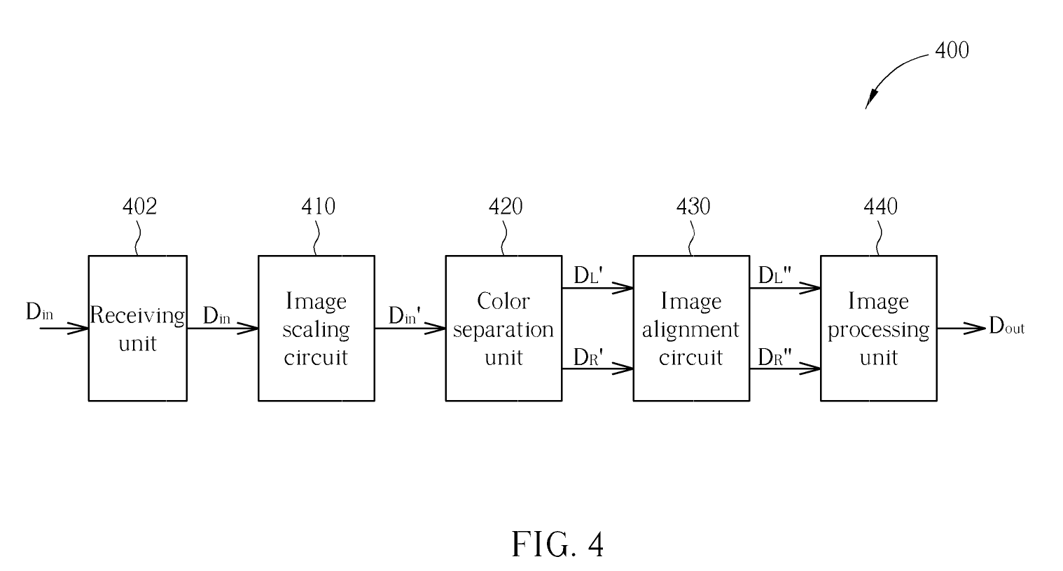

Please refer to FIG. 4, which illustrates an image processing apparatus 400 according to another embodiment of the present invention. As shown in FIG. 4, the image processing apparatus 400 includes a receiving unit 402, an image scaling circuit 410, a color separation unit 420, an image alignment circuit 430 and an image processing unit 440. The image processing apparatus 400 is positioned in a display (not shown) having a 3D display panel or a 2D display panel, and is utilized for performing an image processing operation upon 3D image data Din to generate adjusted 3D image data Dout, where the 3D image data Din can be from a video disc or any other video source. In addition, in this embodiment, the 3D image data Din satisfies HDMI standard.

The operations of the image processing apparatus 400 are similar to the operations of the image processing apparatus 100 shown in FIG. 1 and associated method shown in FIG. 3, and the difference is that: in the image processing apparatus 100, the color separation operation is performed after the image alignment operation; and in the image processing apparatus 400, the color separation operation is performed prior to the image alignment operation. Because a person skilled in this art should understand the operations of the image processing apparatus 400 after reading the above-mentioned descriptions about the image processing apparatus 100 shown in FIG. 1, further descriptions are therefore omitted here.

In addition, the positions of the image scaling circuit 410 on the image processing apparatus 400 is merely an example, and is not to be a limitation of the present invention. In another embodiment of the present invention, the image scaling circuit 410 can be positioned after the color separation unit 420, the image alignment circuit 430 or the image processing unit 440. These alternative designs should fall within the scope of the present invention.

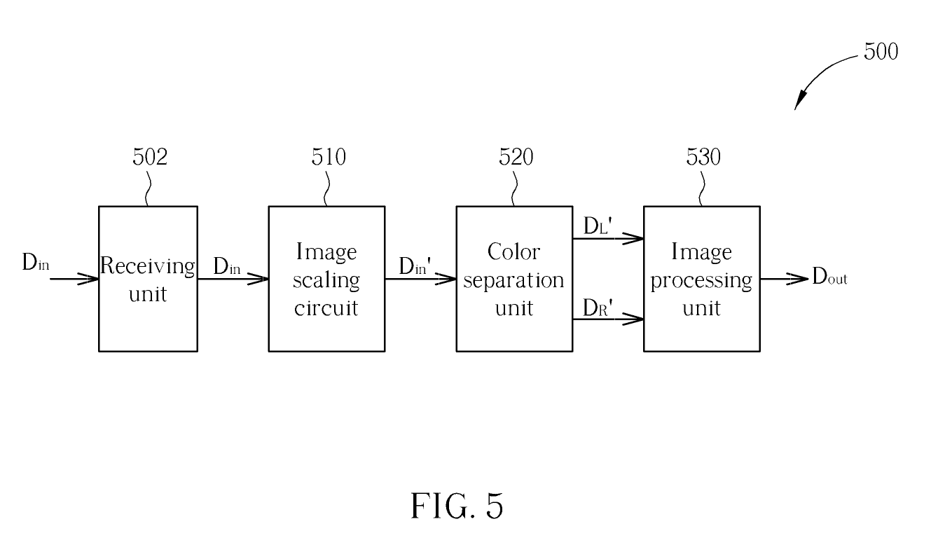

Please refer to FIG. 5, which illustrates an image processing apparatus 500 according to one embodiment of the present invention. As shown in FIG. 5, the image processing apparatus 500 includes a receiving unit 502, an image scaling circuit 510, a color separation unit 520 and an image processing unit 530. The image processing apparatus 500 is positioned in a display (not shown) having a 3D display panel or a 2D display panel, and is utilized for performing an image processing operation upon 3D image data Din to generate adjusted 3D image data Dout, where the 3D image data Din can be from a video disc or any other video source. In addition, in this embodiment, the 3D image data Din satisfies HDMI standard.

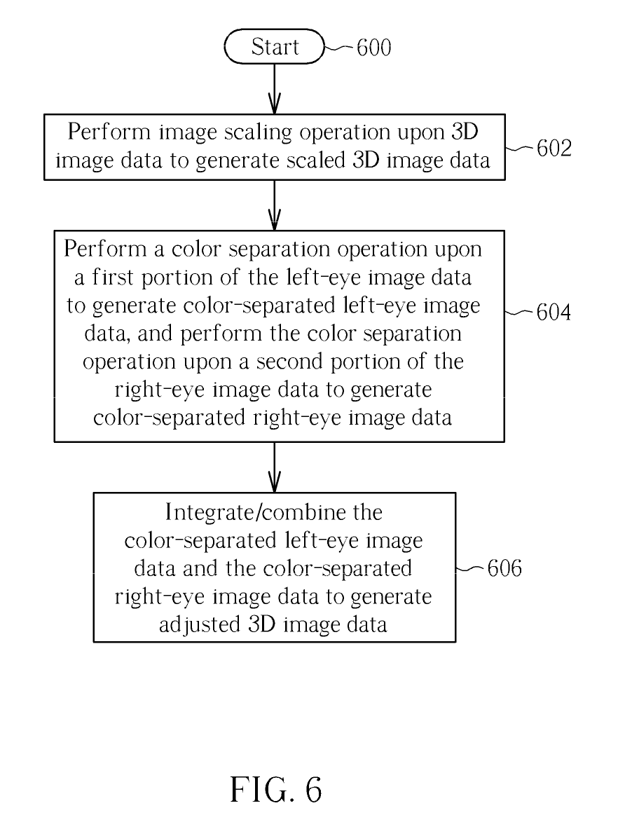

Please refer to FIG. 5 and FIG. 6 together. FIG. 6 is a flow chart of an image processing method according to another embodiment of the present invention. It is noted that, provided the results are substantially the same, the steps are not limited to be executed according to the exact order shown in FIG. 6. Referring to FIG. 6, the flow is described as follows.

In Step 600, the flow starts. Then, in Step 602, the receiving unit 502 receives 3D image data Din, and the image scaling circuit 510 performs an image scaling operation upon the 3D image data Din to generate scaled 3D image data Din′. Taking the video format shown in (b) of FIG. 2 as an example, the image scaling circuit 510 scales up the horizontal pixels of the left-eye image data “L” and the right-eye image data “R” to generate image data having data format similar to the left-eye image data “L” and the right-eye image data “R” shown in (a) of FIG. 2. It is noted that, however, if the 3D image data Din has the video format shown in (a) of FIG. 2, the image scaling circuit 110 does not need to scale the 3D image data Din, that is, the step 302 can be ignored.

Then, in Step 604, the color separation unit 520 performs a color separation operation upon a first portion of the left-eye image data D_{L} to generate a color-separated left-eye image data D_{L}′, and performs the color separation operation upon a second portion of the right-eye image data D_{R} to generate a color-separated right-eye image data D_{R}′, where each of the color-separated left-eye image data D_{L}′ and the color-separated right-eye image data D_{R}′ corresponds to only one or two of three primary colors, the three primary colors include red, green and blue, the color-separated left-eye image data D_{L}′ and the color-separated right-eye image data D_{R}′ do not have the data correspond to the same primary color, and the first portion and the second portion correspond to different pixel positions. For example, the color separation unit 520 may merely perform the color separation operation upon odd scan lines of the left-eye image data D_{L} to generate the color-separated left-eye image data D_{L}′ (e.g., delete the pixel values corresponding to the primary color “red” of the left-eye image data D_{L}), and the color separation unit 520 may merely perform the color separation operation upon even scan lines of the right-eye image data D_{R} to generate the color-separated right-eye image data D_{R}′ (e.g., delete the pixel values corresponding to the primary colors “green” and “blue” of the right-eye image data D_{R}).

Finally, in Step 606, the image processing unit 530 integrates/combines the color-separated left-eye image data D_{L}′ and the color-separated right-eye image data D_{R}′ to generate adjusted 3D image data Dout, and transmits the adjusted 3D image data Dout to the following circuit and to be displayed on a screen. In detail, odd scan lines of a frame of the adjusted 3D image data Dout include the pixel values of the color-separated left-eye image data D_{L}′, and even scan lines of the frame of the adjusted 3D image data Dout include the pixel values of the color-separated right-eye image data D_{R}′. That is, the frame of the adjusted 3D image data Dout includes the pixel values corresponding to the primary colors “green” and “blue” of the left-eye image data D_{L} and the pixel values corresponding to the primary color “red” of the right-eye image data D_{R}. Therefore, the pixel values corresponding to the primary colors “green” and “blue” of the left-eye image data D_{L} and the pixel values corresponding to the primary color “red” of the right-eye image data D_{R} are displayed on the screen simultaneously.

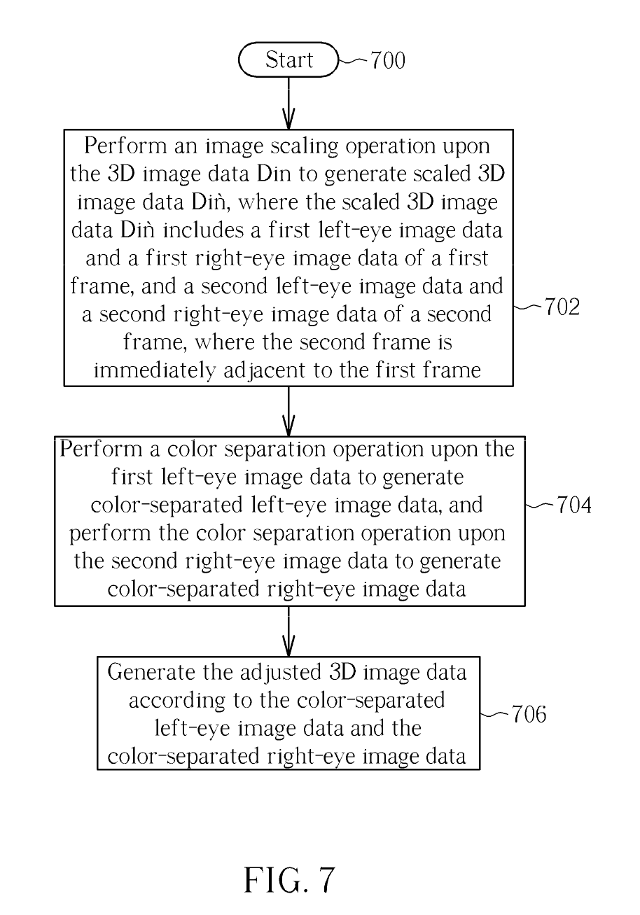

Please refer to FIG. 5 and FIG. 7 together. FIG. 7 is a flow chart of an image processing method according to another embodiment of the present invention. It is noted that, provided the results are substantially the same, the steps are not limited to be executed according to the exact order shown in FIG. 7. Referring to FIG. 7, the flow is described as follows.

In Step 700, the flow starts. Then, in Step 702, the receiving unit 502 receives 3D image data Din, and the image scaling circuit 510 performs an image scaling operation upon the 3D image data Din to generate scaled 3D image data Din′, where the scaled 3D image data Din′ includes a first left-eye image data and a first right-eye image data of a first frame, and a second left-eye image data and a second right-eye image data of a second frame, where the second frame is immediately adjacent to the first frame.

Then, in Step 704, the color separation unit 520 performs a color separation operation upon the first left-eye image data D_{L} to generate a color-separated left-eye image data D_{L}′, and performs the color separation operation upon the second right-eye image data D_{R} to generate a color-separated right-eye image data D_{R}′.

Finally, in Step 706, the image processing unit 530 generates adjusted 3D image data Dout according to the color-separated left-eye image data D_{L}′ and the color-separated right-eye image data D_{R}′, and transmits the adjusted 3D image data Dout to the following circuit and to be displayed on a screen. In this embodiment, the color-separated left-eye image data D_{L}′ and the color-separated right-eye image data D_{R}′ are sequentially and continuously displayed on the screen, and the second left-eye image data of the second frame and the first right-eye image data of the first frame are not displayed on the screen (i.e., the second left-eye image data of the second frame and the first right-eye image data of the first frame are not displayed on the screen are discarded).

In addition, the positions of the image scaling circuit 510 on the image processing apparatus 500 is merely an example, and is not to be a limitation of the present invention. In another embodiment of the present invention, the image scaling circuit 510 can be positioned after the color separation unit 520. This alternative design should fall within the scope of the present invention.

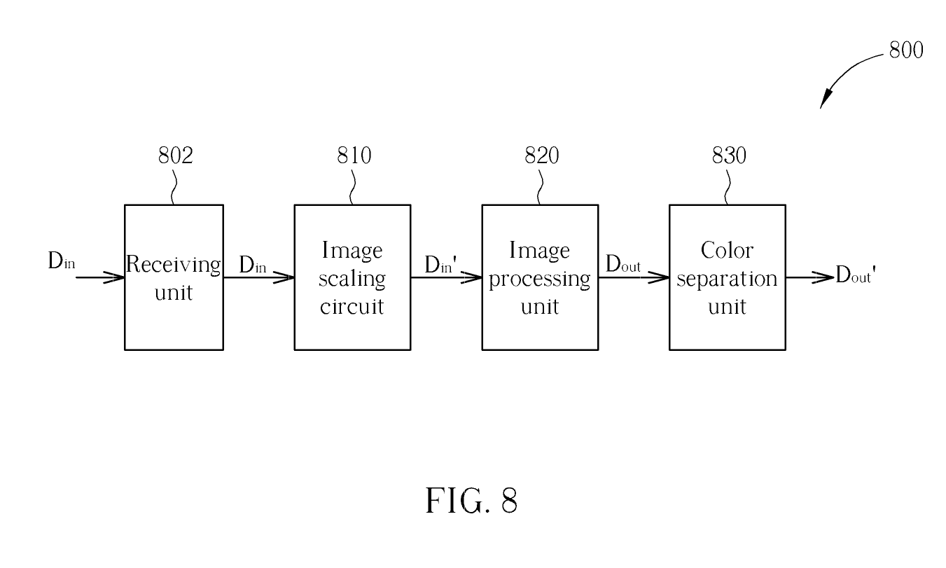

Please refer to FIG. 8, which illustrates an image processing apparatus 800 according to one embodiment of the present invention. As shown in FIG. 8, the image processing apparatus 800 includes a receiving unit 802, an image scaling circuit 810, an image processing unit 820 and a color separation unit 830. The image processing apparatus 800 is positioned in a display (not shown) having a 2D display panel, and is utilized for performing an image processing operation upon 3D image data Din to generate adjusted 3D image data Dout, where the 3D image data Din can be from a video disc or any other video source. In addition, in this embodiment, the 3D image data Din satisfies HDMI standard.

The operations of the image processing apparatus 800 are similar to the operations of the image processing apparatus 500 shown in FIG. 5 and associated methods shown in FIGS. 6 and 7, and the difference is that: in the image processing apparatus 500 shown in FIG. 5, the image processing apparatus 500 performs the color separation operation to generate the color-separated left-eye image data D_{L}′ and the color-separated right-eye image data D_{R}′, and then generates the adjusted 3D image data Dout according to the color-separated left-eye image data D_{L}′ and the color-separated right-eye image data D_{R}′; however, the image processing apparatus 800 performs image processing operation first to generate processed image data Dout (i.e., converting the 3D image data Din into 2D video format, for example, combines/integrates the pixels of odd scan lines of the left-eye image data the pixels of even scan lines of the right-eye image data to generate new 2D image data), and then performs the color separation operation upon the processed image data Dout to generate adjusted 3D image data Dout′. Because a person skilled in this art should understand the operations of the image processing apparatus 800 after reading the above-mentioned descriptions about the image processing apparatus 500 shown in FIG. 5, further descriptions are therefore omitted here.

In addition, the image processing apparatuses 100, 400, 500 and 800 performs the color separation operations and other image processing operations upon the 3D image data Din to generate the adjusted 3D image data Dout/Dout′ in a real-time manner, and the adjusted 3D image data Dout/Dout′ is real-time displayed on the screen.

Briefly summarized, in the image processing apparatus and the image processing method of the present invention, 3D image data are performed by a color separation operation to generate the adjusted 3D image data to be displayed on a 2D display or a 3D display. Therefore, the user can enjoy the 3D video without buying the expensive 3D TV and the peripheral device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing apparatus, positioned in a display, comprising:
a receiving unit, for receiving 3D image data, where the 3D image data includes left-eye image data and right-eye image data;
a color separation unit, coupled to the receiving unit, for performing a color separation operation upon at least a portion of the left-eye image data to generate color-separated left-eye image data, and performing the color separation operation upon at least a portion of the right-eye image data to generate color-separated right-eye image data, where each of the color-separated left-eye image data and the color-separated right-eye image data corresponds to one or two of three primary colors, the three primary colors include red, green and blue, and the color-separated left-eye image data and the color-separated right-eye image data do not have the data correspond to a same primary color; and
an image processing unit, coupled to the color separation unit, for generating adjusted 3D image data according to the color-separated left-eye image data and the color-separated right-eye image data.

2. The image processing apparatus of claim 1, wherein the color separation unit performs the color separation operation upon all of the left-eye image data to generate the color-separated left-eye image data, and performing the color separation operation upon all of the right-eye image data to generate the color-separated right-eye image data.

3. The image processing apparatus of claim 1, wherein the image processing unit directly integrates/combines the color-separated left-eye image data and the color-separated right-eye image data to generate the adjusted 3D image data.

4. The image processing apparatus of claim 1, wherein the color separation unit performs the color separation operation upon only a first portion of the left-eye image data to generate the color-separated left-eye image data, and performing the color separation operation upon only a second portion of the right-eye image data to generate the color-separated right-eye image data; and the image processing unit generates the adjusted 3D image data according to the color-separated left-eye image data and the color-separated right-eye image data, where the first portion and the second portion correspond to different pixel positions.

5. The image processing apparatus of claim 4, wherein data corresponding to the first portion of the left-eye image data and the second portion of the right-eye image data are displayed on a screen of the display simultaneously.

6. The image processing apparatus of claim 1, wherein the left-eye image data includes first left-eye image data of a first frame and second left-eye image data of a second frame, and the right-eye image data includes first right-eye image data of the first frame and second right-eye image data of the second frame, where the second frame is immediately adjacent to the first frame; and the color separation unit performs the color separation operation upon the first left-eye image data to generate the color-separated left-eye image data, and performing the color separation operation upon the second right-eye image data to generate the color-separated right-eye image data.

7. The image processing apparatus of claim 6, wherein the color-separated left-eye image data and the color-separated right-eye image data are sequentially and continuously displayed on the screen, and the second left-eye image data of the second frame and the first right-eye image data of the first frame are not displayed on a screen of the display.

8. The image processing apparatus of claim 1, wherein the image processing apparatus performs the color separation operations and image processing operations upon the 3D image data to generate the adjusted 3D image data in a real-time manner, and the adjusted 3D image data is displayed on a screen of the display.

9. The image processing apparatus of claim 1, further comprising:
an image alignment circuit, coupled between the receiving unit and the color separation unit, for aligning pixels having the same positions of the left-eye image data and the right-eye image data.

10. The image processing apparatus of claim 1, further comprising:
an image alignment circuit, coupled between the color separation unit and the image processing unit, for aligning pixels having the same positions of the color-separated left-eye image data and the color-separated right-eye image data.

11. An image processing method, applied to a display, comprising:
receiving 3D image data, where the 3D image data includes left-eye image data and right-eye image data;
performing a color separation operation upon at least a portion of the left-eye image data to generate color-separated left-eye image data, and performing the color separation operation upon at least a portion of the right-eye image data to generate color-separated right-eye image data, where each of the color-separated left-eye image data and the color-separated right-eye image data corresponds to one or two of three primary colors, the three primary colors include red, green and blue, and the color-separated left-eye image data and the color-separated right-eye image data do not have the data correspond to a same primary color; and
generating adjusted 3D image data according to the color-separated left-eye image data and the color-separated right-eye image data.

12. The image processing method of claim 11, wherein the step of generating the adjusted 3D image data comprises:
performing the color separation operation upon only a first portion of the left-eye image data to generate the color-separated left-eye image data;
performing the color separation operation upon only a second portion of the right-eye image data to generate the color-separated right-eye image data;
generating the adjusted 3D image data according to the color-separated left-eye image data and the color-separated right-eye image data, where the first portion and the second portion correspond to different pixel positions.

13. The image processing method of claim 11, wherein the left-eye image data includes first left-eye image data of a first frame and second left-eye image data of a second frame, and the right-eye image data includes first right-eye image data of the first frame and second right-eye image data of the second frame, where the second frame is immediately adjacent to the first frame; and the step of generating the color-separated left-eye image data and the color-separated right-eye image data comprises:
performing the color separation operation upon the first left-eye image data to generate the color-separated left-eye image data, and performing the color separation operation upon the second right-eye image data to generate the color-separated right-eye image data.

14. The image processing method of claim 11, further comprising:
aligning pixels having the same positions of the left-eye image data and the right-eye image data.

15. The image processing method of claim 11, further comprising:
aligning pixels having the same positions of the color-separated left-eye image data and the color-separated right-eye image data.

16. An image processing apparatus, positioned in a display, comprising:
a receiving unit, for receiving 3D image data, where the 3D image data includes left-eye image data and right-eye image data;
an image processing unit, coupled to the receiving unit, for processing the left-eye image data and the right-eye image data to generate processed left-eye image data and processed right-eye image data, respectively; and
a color separation unit, coupled to the image processing unit, for performing a color separation upon at least a portion of the processed left-eye image data to generate color-separated left-eye image data, and performing the color separation upon at least a portion of the processed right-eye image data to generate color-separated right-eye image data, where each of the color-separated left-eye image data and the color-separated right-eye image data corresponds to one or two of three primary colors, the three primary colors include red, green and blue, and the color-separated left-eye image data and the color-separated right-eye image data do not have the data correspond to a same primary color.

17. A display, comprising:
a display panel; and
an image processing apparatus, coupled to the display panel, wherein the image processing apparatus comprises:
a receiving unit, for receiving 3D image data, where the 3D image data includes left-eye image data and right-eye image data;
a color separation unit, coupled to the receiving unit, for performing a color separation operation upon at least a portion of the left-eye image data to generate a color-separated left-eye image data, and performing the color separation operation upon at least a portion of the right-eye image data to generate a color-separated right-eye image data, where each of the color-separated left-eye image data and the color-separated right-eye image data corresponds to one or two of three primary colors, the three primary colors include red, green and blue, and the color-separated left-eye image data and the color-separated right-eye image data do not have the data correspond to a same primary color; and
an image processing unit, coupled to the color separation unit, for generating adjusted 3D image data according to the color-separated left-eye image data and the color-separated right-eye image data.

18. The display of claim 17, wherein the display panel is a 2D display panel.

19. The display of claim 17, wherein the display panel is a 3D display panel.
